(19) United States
(12) Patent Application Publication
(10) Pub. No.: US 2006/0269132 A1
(43) Pub. Date: Nov. 30, 2006

(54) Apparatus and method for detecting white areas within windows and selectively merging the detected white areas into the enclosing window

(75) Inventors: David Jon Metcalfe, Marion, NY (US); Stuart A. Schweid, Pittsford, NY (US); Jeng-Nan Shiau, Webster, NY (US)

Correspondence Address: OLIFF & BERRIDGE, PLC., P.O. BOX 19928, ALEXANDRIA, VA, 22320, US

(73) Assignee: XEROX CORPORATION, Stamford, CT (US)

(21) Appl. No.: 11/139,546

(22) Filed: May 31, 2005

(51) Int. Cl. G06K 9/34; G06K 9/00

(52) U.S. Cl. 382/176; 382/168

(57) ABSTRACT

Methods and apparatus for segmenting image data into one or more windows may collect statistics on white regions, otherwise called enclosed white windows. Such enclosed white windows may be merged with one of a surrounding nonwhite window and a background based upon the enclosed white window's size, edge characteristics, cumulative statistics and/or at least one control parameter. Such merging may be accomplished at a time subsequent to enclosing the white region or dynamically while the window is being assembled scanline-by-scanline.

Cross-reference is made to co-pending, commonly assigned applications, including: U.S. application Ser. No. ______, filed ______, entitled “Apparatus and Method for Sub-Typing Window Elements in a Document Windowing System” to Schweid et al., and U.S. application Ser. No. ______, filed ______, entitled “Apparatus and Method for Auto Windowing Using Multiple White Thresholds” to Metcalfe et al., (Attorney Docket Nos. 123341 and 123343) which are incorporated herein by reference in their entirety.

### BACKGROUND

The present disclosure relates to methods and apparatus for segmenting a page of image data into one or more windows and for classifying the image data within each window as a particular type of image data. Specifically, the present disclosure relates to apparatus and methods for differentiating background from document content.

Image data is often stored in the form-of multiple scanlines, each scanline comprising multiple pixels. When processing such image data, it is helpful to know the type of image represented by the data. For instance, the image data may represent graphics, text, a halftone, continuous tone, or some other recognized image type. A page of image data may be all one type, or some combination of image types.

It is known in the art to separate the image data of a page into windows of similar image types. For instance, a page of image data may include a halftone picture with accompanying text describing the picture. It is further known to separate the page of image data into two or more windows, a first window including the halftone image, and a second window including the text. Processing of the page of image data may then be carried out by tailoring the processing of each area of the image to the type of image data being processed as indicated by the windows.

It is also known to separate a page of image data into windows and to classify and process the image data within the windows by making either one or two passes through the page of image data. Generally, images are presented to processing equipment and processed in a raster or other fashion such that at any given time, only a certain portion of the image data has been seen by the processing equipment, the remaining portion yet to be seen.

In a one pass system the image data is run through only once, whereas in a two pass system the image data is run through twice. The second pass does not begin until some time after the first pass has completed. A one pass method is generally quicker, but does not allow the use of “future” context to correct information that has already been generated. In a two pass method, information obtained for a third or fourth scanline may be used to generate or correct information on a first or second scanline, for example. In other words, during the second pass, “future” context may be used to improve the rendering of the image data because the image data was previously processed during the first pass.

During the first pass of a two pass method, pixels may be classified, tagged according to image type, and both the image video and classification tag stored. Such tags and image video may analyzed and the results used to associate pixels into larger windows. Statistics on the image video and classification tags for these windows may be gathered for each window, as well as for the area outside of all windows. After the first pass finishes but before the second pass begins, software may read the window and non-window statistics and may use calculations and heuristic rules to classify the delineated areas of windows and non-windows. During the second pass, the results of this classification, as well as the pixel tag and image video from the first pass, may be used to control optimized processing of the image video.

Typically, windows within a document image are detected as areas separated by white areas of the document. Exemplary methods and apparatus for classifying image data are discussed in U.S. Pat. Nos. 5,850,474 and 6,240205 to Fan et al., each of which is incorporated herein by reference in its entirety. Typically, such windowing methods depend heavily on the luminance and/or chrominance of the video to delineate the boundaries of windows.

### SUMMARY

Exemplary methods and apparatus for auto windowing (“windowing”), that is, segmenting image data into one or more windows, may collect statistics on white regions, otherwise called enclosed white windows. Such enclosed white windows may be merged with surrounding windows based upon the enclosed-white window's size, edge characteristics, cumulative tag statistics and/or at least one control parameter.

Such methods and apparatus for windowing image data may be incorporated in scanning devices and may comprise separating and keeping track of pixels labeled as “background” area vs. “non-background” area. Such methods may also include classifying the image data within a window as a particular image type and recording statistics regarding the window and image type of each pixel.

To improve efficiency, window labels, or IDs, may be allocated on an ongoing basis during, for example, first-pass processing, while at the same time dynamically compiling window ID equivalence information. Once the image type for each window is known, further processing of the image data may be more optimally specified and performed.

Exemplary embodiments may automatically locate a window contained within a document. A window is defined herein as any non-background area, such as a photograph or halftone picture, but may also include text, background noise and white regions. Various embodiments described herein include two passes through the image data.

During a first pass through the imaged data, a classification module may classify pixels may as white, black, edge, edge-in-halftone, continuous tone (rough or smooth), and halftones over a range of frequencies. Concurrently, a window detection module may generate window-mask data, may collect statistics, and may develop an ID equivalence table, all to separate the desired windows from undesired regions.

Windowing may be accomplished by identifying and keeping track of pixels labeled as “background” vs. “non-background” and by combining image-run sections of scanlines to form windows. Statistics on pixel classification within each window may then compiled and examined.

Known first pass window operation methods may be used to accomplish these functions, including the methods described in the aforementioned Fan references, the entire disclosures of which are hereby incorporated by reference.

During a second pass through the image data, pixel tags may be modified by a retagging module, replacing each pixel's first-pass tag with a new tag indicating association with a window. These tags may be later used to control downstream processing or interpretation of the image.

It has been observed that the aforementioned windowing methods are problematic when documents include background, or white, areas that are completely surrounded with nonwhite document content. Depending upon details of the window detection and statistic collection algorithm, the enclosed white area may be ignored and treated as background, or the white area may be blindly included as part of the surrounding non-window as an outcome of the topological analysis detecting the window. In either case, the windowing and typing of the image as a result of the first pass may be incorrect, and as a result, the processing of the page of image data may not be optimal.

Exemplary embodiments of windowing methods and apparatus disclosed herein may track and collect statistics on white runs and white windows in the same way as nonwhite runs and nonwhite windows. Thus, white runs may be intentionally included or excluded in their enclosing window based upon gathered statistics and/or at least one control parameter.

Although merging may be accomplished at any time subsequent to enclosing the white region, the enclosed white region may be merged dynamically while the window is being assembled scanline-by-scanline.

Such windowing embodiments disclosed herein may be incorporated in an imaging device, such as a xerographic imaging system.

### BRIEF DESCRIPTION OF THE DRAWINGS

Various exemplary embodiments are described in detail, with reference to the following figures, wherein:

FIG. 1 shows a flowchart illustrating an exemplary two pass windowing method.

FIG. 2 shows a block diagram of an exemplary two pass windowing apparatus.

FIG. 3 illustrates an image page in which relatively small white window areas may be merged into a surrounding window.

FIG. 4 illustrates an image page in which white window areas within a nonwhite window may be merged into a background.

FIG. 5 illustrates a flowchart illustrating an exemplary enclosed white/nonwhite Window ID remapping method.

### DETAILED DESCRIPTION OF EMBODIMENTS

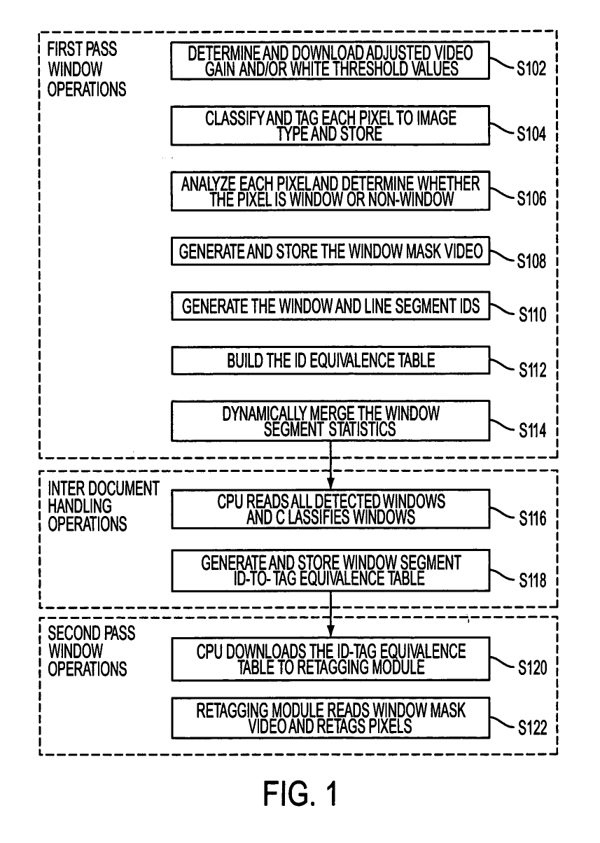

Apparatus and methods for detecting white areas within windows may be incorporated within image scanners and may include two passes through the image data. FIG. 1 is a flowchart illustrating an exemplary two pass windowing method.

The exemplary method classifies each pixel as a particular image type, separates a page of image data into windows and background, collects document statistics on window areas, non-window areas and pixel image type and retags pixels appropriately based upon the collected statistics. Once the image type for each window is known, rendering, or other processing modules, not shown, may process the image data and do so more optimally than if the windowing and retagging were not performed.

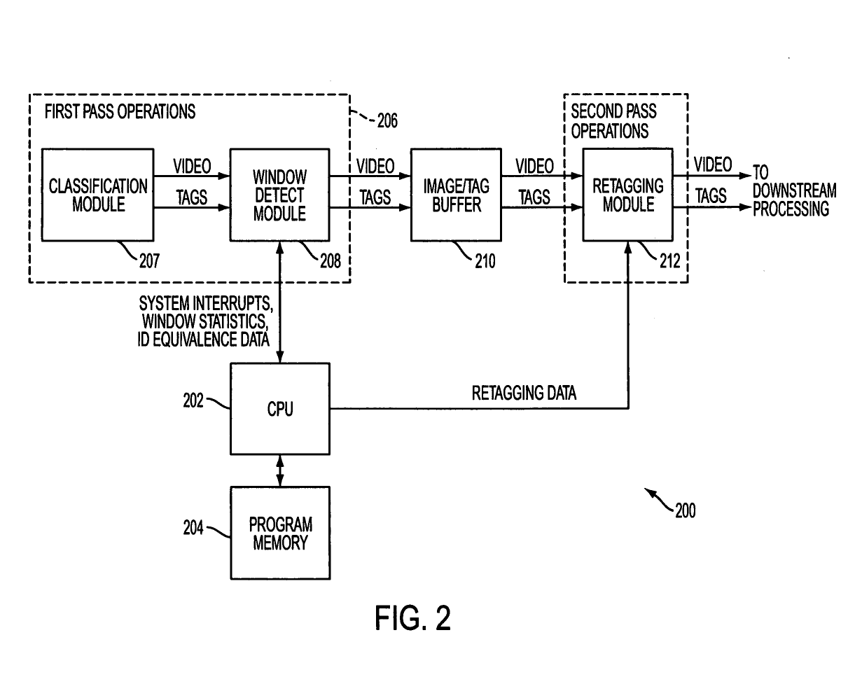

A block diagram of an exemplary two pass windowing system 200 that may carry out the exemplary method is shown in FIG. 2. The exemplary system 200 may include a central processing unit (CPU) 202 in communication with a program memory 204, a first pass operations module 206 including a classification module 207 and a window detection module 208, a RAM image buffer 210 and a retagging module 212. The CPU 202 may transmit and/or receive system interrupts, statistics, ID equivalence data and other data to/from the window detection module 208 and may transmit pixel retagging data to the retagging module 212. The first pass and second pass operations may be implemented in a variety of different hardware and software configurations, and the exemplary arrangement shown is non-limiting.

During the first pass through the image data, pixels may be classified by the classification module 207 into, for example, white, black, edge, edge in halftone, continuous tone, and halftones over a range of frequencies. Segmentation tags, edge strength tags and video may be sent to the window detection module 208, which may use such tags and video to associate pixels with various windows and calculate various statistics for each window created.

Although default control parameters for background white threshold and background gain may be used initially, once sufficient statistics are collected, subsequent values may be determined and downloaded by the CPU 202, in step S102, to the window detection module 208. Using such subsequent values may improve the determination of whether a pixel is part of a window or is background. A detailed description of such control parameters is provided below.

As the image is scanned and stored, each pixel may, in step S104, be classified and tagged by the classification module 207 as being of a specific image type. In the exemplary embodiment shown in FIG. 1, the tags may also be stored. Alternatively, however, the tags may not be stored for later use, instead, they may be recreated at the beginning of the second pass. In addition, step S104 may be performed concurrently with step S102. The order of the steps shown in FIG. 1 is exemplary only and is non-limiting.

An exemplary approach to pixel classification may include comparing the intensity of a pixel to the intensity of its surrounding neighboring pixels. A judgment may then be made as to whether the intensity of the pixel under examination is significantly different than the intensity of the surrounding pixels. When a pixel has a significantly high luminance, the pixel may be classified as a background pixel. However, as discussed below, pixels adjacent to window objects may be uncertain in this regard.

Subsequent to pixel classification, the window detection module 208 may, in step S106, analyze each pixel and may determine whether the pixel is window or background. Exemplary methods described herein may better define an outline around window objects by using at least one control parameter specific to determining whether pixels belong to window or background areas. Such control parameters may include a background gain parameter and/or a background white threshold parameter that may be predetermined or calculated and may be distinct from other gain and/or white threshold levels used by the classification step S104 to classify a “white” pixel with a white tag.

In step S108, a window mask may be generated as the document is scanned and stored into image/tag buffer 210. The scanned image data may comprise multiple scanlines of pixel image data, each scanline typically including intensity information for each pixel within the scanline, and, if color, chroma information. Typical image types include graphics, text, white, black, edge, edge in halftone, continuous tone (rough or smooth), and halftones over a range of frequencies.

During step, S110, performed by the classification module 207, window and line segment IDs may be allocated as new widow segments are encountered. For example, both video and pixel tags may be used to identify those pixels within each scanline that are background and those pixels that belong to image-runs. The image type of each image run may then be determined based on the image type of the individual pixels. Such labels, or IDs, may be monotonically allocated as the image is processed.

In step S112, the window detection module 208 may dynamically compile window ID equivalence information and store such data in an ID equivalent table, for example.

Also in step S112, decisions are made to discard windows and their associated statistics which have been completed without meeting minimum window requirements.

In step S114, at the end of the first pass, an ID equivalence table and the collected statistics may be analyzed and processed by the window detection module 208. When processing is completed, the window detection module 208 may interrupt the CPU 202 to indicate that all the data is ready to be retrieved.

Typically, while a document image is initially scanned, the windowing apparatus performs its first pass through the document image. In order to optimize processing speed, a subsequent image may be scanned and undergo first pass windowing operations concurrent with the second pass of the first image. However, after the first pass operations finish, but before the second pass begins, inter-document handling may be performed by the CPU 202.

In step S116, the CPU may read the statistics of all windows that have been kept and apply heuristic rules to classify the windows. Windows may be classified as one of various video types, or combinations of video types.

In addition, between the first and second pass operations, the CPU 202 may generate and store, in step S118, a window segment ID-to-Tag equivalence table.

During a second pass, pixels may be tagged by the retagging module 212. In step S120, the CPU 202 may download retagging data comprising the window segment ID-to-Tag equivalence table to the retagging module 212. In step S122, the retagging module 212 may read the window mask from the image buffer 210 and may retag pixels within all selected windows with an appropriate uniform tag based upon the ID-to-Tag equivalence table.

Once each portion of the image data has been classified according to image types, further processing of the image data may be performed more optimally.

Referring back to the first pass scan processing, the logic may detect “background” within the confines of a nonwhite window. Such areas may be labeled as “enclosed-white windows.” Such regions may be merged with the surrounding region's statistics upon determination that such white areas are indeed enclosed by a common window object.

The determination may be based upon the enclosed white window's size, edge characteristics, cumulative tag statistics and for other pre-defined criteria, and may be done at any time subsequent to enclosing the white region, or may be done dynamically while the window is being assembled scanline-by-scanline. The actual remapping in the ID-to-Tag equivalence table may be done sometime thereafter.

An exemplary method may comprise at least one control parameter that may be predetermined and downloaded during an initial parameter download time. Such a control parameter may be used to evaluate and enclose, if appropriate, white windows into window or background areas.

A BackGround Size parameter may store the minimum pixel-size area that must be reached before being considered a “background” window. Because both white and nonwhite windows may be allocated their own IDs, the white regions may either be merged with their surrounding window ID, or mapped to point to the background area. This decision may be made dynamically while the window is being assembled scanline-by-scanline.

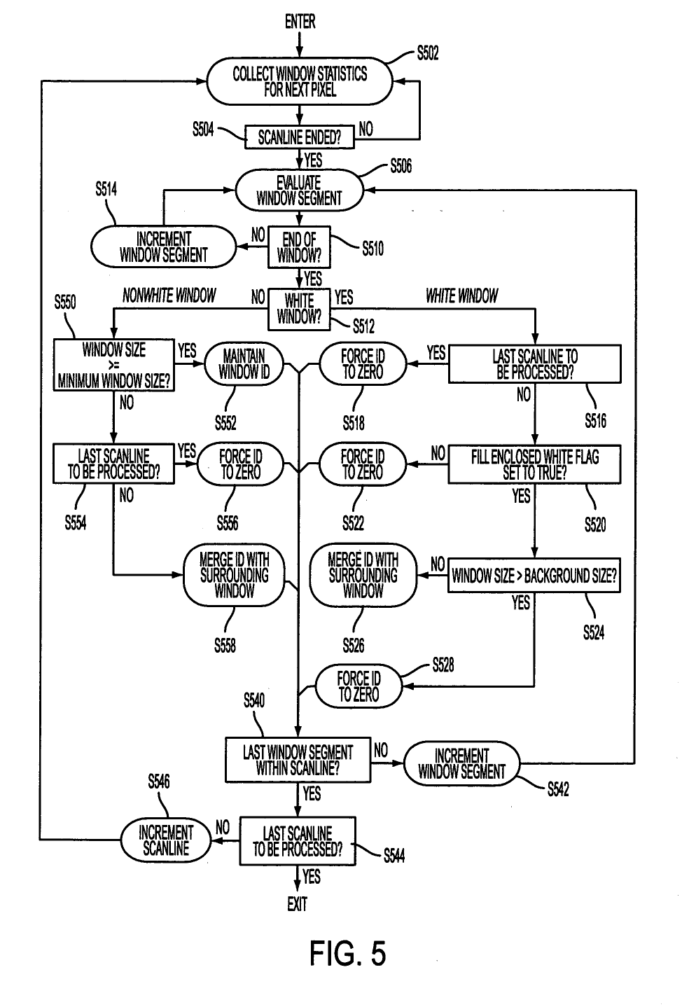

A Fill Enclosed White Flag, which when set to true, may allow all white windows that are labeled as “enclosed” and also satisfy some additional conditions, to be combined and included with its surrounding nonwhite window, as illustrated in the flowchart of FIG. 5. Likewise, all white windows, regardless of size, may not be merged with their neighbor window when this parameter is set to false.

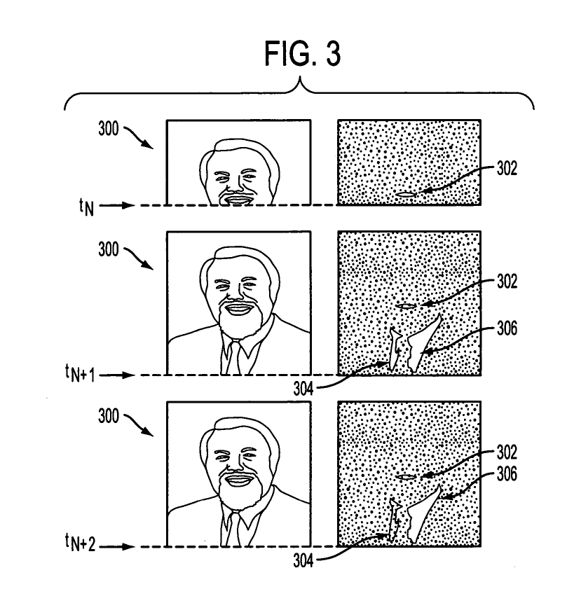

FIG. 3 illustrates a case where a larger window 300 includes white regions 302, 304, 306 which are small enough to be considered “enclosed” windows. At time tN, the end of white window 302 is detected and its overall area may found to be less than the BackGround Size threshold value. In this case, the window may be “merged” with the surrounding area by combining the overall statistics. In addition, the ID equivalence table may be updated by equating the IDs of the two window regions. The same merging may be accomplished for white windows 304 and 306 that are encountered later at times tN+1 and tN+2, respectively.

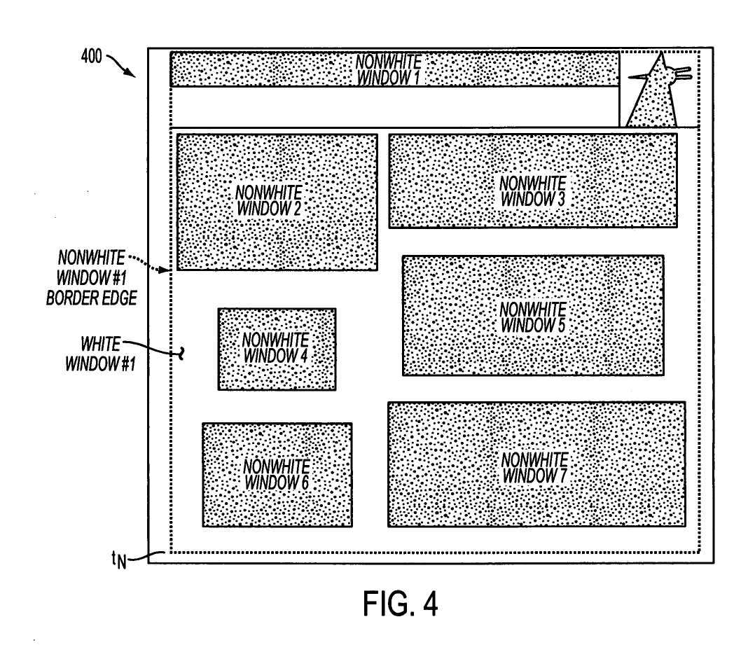

FIG. 4 shows an image 400 that may illustrate the advantages of mapping an enclosed white region to a background window. NonWhiteWindow 1 through NonWhiteWindow 7 are enclosed within the NonWhiteWindow 1 BorderEdge. In this case, separate windows may be generated by mapping the enclosed White Window 1 to background when the scanline comprising NonWhiteWindow 1 BorderEdge is processed at time tN.

FIG. 5 is a flowchart illustrating an exemplary method that may be executed within step S112, for example, whereby the classification module 207 determines whether to enclosed white/nonwhite windows and to classify windows as “window” or “background.”

In step S502, statistics may be collected for the next pixel. In step S504, a determination may be made whether the scanline has been completely processed. If not, control may return to step S502. If the scanline is complete, a first window segment within the scanline may be evaluated in step S506.

If analysis of the window segment in step S510 indicates the end of a current open window, control may be passed to step S512. Otherwise, the window segment may be incremented in step S514 and control may return to step S506.

If the classification module 206 determines, in step S512, that the window is a white window, white window processing may be initiated in step S516. Otherwise, nonwhite window processing may initiated in step S550.

In step S550, if the window size is greater or equal to a minimum window size, the current window ID for that window may be maintained in step S552 and processing continues in step S540 to determine whether the window segment was the last segment within the present scanline. If not the last window segment within the scanline, the window segment may be incremented in step S542 and control may return to step S506 to process the next window segment.

If the result of step S540 indicates that the scanline under test is the last window segment within the scanline, a decision may be made in step S544, as to whether the current scanline is the last scanline to be processed. If the scanline is the last scanline, control may exit the program module S500, ending the method. Otherwise, the scanline may be incremented in step S546 and control may return to step S502.

If the result of step S550 indicates that the window size is not as large as, or larger than, the minimum window size, control may continue to step S554 to evaluate whether the scanline is the last scanline to be processed. If the last scanline, the window ID may be changed in step S556 to indicate background, and control may pass to step S540 to processed as described above.

If the current scanline is not the last scanline, control may continue from step S554 to step S558, in which the window ID may merge with the surrounding window before continuing to step S540.

Referring back to step S512, if the window just completed is a white window, control may continue to step S516. If the current scanline is the last scanline of the page, the window ID may be changed in step S518 to a background tag and control may continue at step S540. If the result of step S516 is no, the window ID may still be set to background in step S520 depending upon if the Fill Enclosed White Flag, checked in step S520, is not set.

If the Fill Enclosed White Flag is set, the size of the enclosed white window may be tested in step S524. If the size of the enclosed white window is less than a predetermined minimum number of pixels, then in step S526, the enclosed white window may be merged to its nonwhite surrounding window ID. Otherwise, processing may continue to step S528.

In step S528, the white window may be merged with the background, by taking on the ID of the background before continuing in step S540.

The above tests are non-limiting. Other control and document parameters may be used in conjunction with the above to determine whether an enclosed white window should be merged within either the surrounding non-white window or the background.

It will be appreciated that various of the above-disclosed and other features and functions, or alternatively thereof, may be desirably combined into many other different systems or applications. Also, various presently unforeseen or unanticipated alternatives, modifications, variations or improvements therein may be subsequently made by those skilled in the art and are also intended to be encompassed by the following claims.

What is claimed is:

1. A windowing method, comprising:
merging an enclosed white window into one of a background and a surrounding window.

2. The method according to claim 1, further comprising:
classifying each pixel within a scanline as to an image type;
collecting statistics;
classifying a window as an enclosed white window, wherein the enclosed white window includes an area of white image type pixels within a surrounding nonwhite window; and
determining whether to merge the enclosed white window into one of a background and a surrounding window based upon the collected statistics.

3. The method according to claim 2, wherein classifying each pixel includes:
classifying a pixel as white based on a white pixel classification threshold.

4. The method according to claim 1, wherein merging an enclosed white window into one of a background and a surrounding window comprises determining whether the enclosed white window is greater than a minimum background size.

5. The method according to claim 2, wherein merging the enclosed white window within one of the surrounding window and the background comprises changing a window ID of the enclosed white window to a window ID of one of the surrounding window and the background.

6. The method according to claim 2, wherein merging the enclosed white window within one of the surrounding window and the background is done dynamically based upon at least one of a size of the enclosed white window, edge characteristics, cumulative tag statistics and a predetermined control parameter.

7. The method according to claim 2, wherein merging the enclosed white window within one of the surrounding window and the background is done upon determination that a window comprising pixels classified as white image type has been enclosed.

8. A windowing apparatus, comprising:
at least one logic module, the at least one logic module being configured to merge an enclosed white window into one of a background and a surrounding window.

9. The apparatus according to claim 8, wherein the at least one logic module is configured to merge a white region into one of the background and the surrounding window after the white region has been enclosed.

10. The apparatus according to claim 8, wherein the at least one logic module is configured to collect statistics and to merge an enclosed white window into one of a background and a surrounding window based upon the collected statistics.

11. The apparatus of claim 9, wherein the at least one logic module is configured to merge the enclosed white window into one of background and surrounding window upon determining that the white region has been enclosed.

12. The apparatus of claim 8, wherein the at least one logic module is configured to merge the enclosed white window into one of background and surrounding window based upon at least one control parameter.

13. The apparatus according to claim 12, wherein the at least one control parameter further comprises a background size parameter.

14. The apparatus according to claim 8, wherein the at least one logic module is configured to change a window ID of the enclosed white window to a window ID of one of the background and surrounding window to merge the enclosed white window into one of background and surrounding window.

15. A xerographic imaging system, comprising a document scanning device including the windowing apparatus of claim 8.

16. A computer readable medium comprising program instruction code, the program instruction code configured to:
merge an enclosed white window into one of a background and a surrounding window.

17. The medium according to claim 16, wherein the program instruction code is further configured to:
identify an enclosed white window, wherein the enclosed white window is surrounded by a nonwhite surrounding window; and
evaluate the enclosed white window based upon collected statistics.

18. The medium according to claim 16, wherein the program instruction code is configured to evaluate the enclosed white window based upon a minimum background size.

19. The medium according to claim 16, wherein the program instruction code is configured to change a window ID of the enclosed white window to an ID of one of the surrounding window and the background.
